(19) United States
(12) Patent Application Publication
(10) Pub. No.: US 2008/0089751 A1
(43) Pub. Date: Apr. 17, 2008

(54) SLEEVE CUTTER

(75) Inventors: Charles G. Hutter, Carson City, NV (US); David D. Webster, Reno, NV (US)

Correspondence Address: KELLY LOWRY & KELLEY, LLP, 6320 CANOGA AVENUE, SUITE 1650, WOODLAND HILLS, CA, 91367, US

(73) Assignee: PHYSICAL SYSTEMS, INC., Carson City, NV (US)

(21) Appl. No.: 11/867,961

(22) Filed: Oct. 5, 2007

Related U.S. Application Data
(60) Provisional application No. 60/829,118, filed on Oct. 11, 2006.

(51) Int. Cl. B23B 27/08

(52) U.S. Cl. 408/25; 408/104; 408/42

(57) ABSTRACT

A sleeve cutter is provided for precision cutting of a length of metal tubing or the like. The sleeve cutter includes a mandrel or spindle for supporting a tube-shaped sleeve thereon between a pair of rotary-driven cutting wheels adapted for movement together between retracted positions spaced outwardly from the mandrel, and advanced position with cutting edges in engagement with the mandrel-supported sleeve. Each cutting wheel further includes a shaping step or land for removing any burr or flare from the cut sleeve end.

### BACKGROUND OF THE INVENTION

This invention relates generally to a system and method for cutting a tube-shaped sleeve or the like with a predetermined and precision selected cut length. More specifically, this invention relates to a sleeve cutter and related cutting method for quickly and efficiently cutting sleeves of the type used in fastener installation through an access port formed in a substrate panel, e.g., as shown and described in U.S. Pat. No. 5,704,747.

In many manufacturing environments, it is necessary or desirable to install components onto a blind or reverse side of a supporting substrate. As one common example, nutplates are well known in the automotive and aerospace industries for use in mounting a threaded nut or the like onto the blind side of a supporting substrate, typically in alignment with an access port formed in the substrate, to accommodate subsequent reception of a mating fastener component such as a threaded screw or bolt. Such nutplates include a fastener element such as a floating or fixed nut carried by a base which is fastened to the substrate as by adhesively bonding the nutplate base onto the substrate blind side. For optimum bond strength, such adhesive mounting techniques require the nutplate base to be pressed against the substrate with a positive force during curing of the adhesive material. U.S. Pat. Nos. 5,013,391 and 5,704,747, both of which are incorporated by reference herein, disclose adhesive mounted nutplate assemblies and related mounting fixtures for quickly and easily installing the nutplate assembly onto the substrate blind side, and for thereafter removing the fixture from the front side of the substrate.

The substrate with one or more nutplate assemblies secured to the blind side thereof is then assembled with adjoining frame structures and/or additional panel-shaped substrate elements, typically in an automotive or aerospace assembly line, to render the blind side of the substrate substantially inaccessible. Further assembly processes include reception of a mating fastener component such as a threaded bolt or screw through each access port in threaded engagement with the blind side-supported threaded nut.

In some nutplate assembly configurations, a liner sleeve is provided for lining the access port formed in the substrate. In this regard, the liner sleeve is commonly formed from a metal tube or tubing material such as a work hardened stainless steel with a standard diametric size and a standard axial length, and typically also including a radially enlarged flange at one end thereof. The tubular liner sleeve is fitted through the substrate access port to limit or prevent hole wear, particularly in the case of a substrate formed from a composite or other non-metal material. The liner sleeve also accommodates the use of standard-sized fasteners with an otherwise oversize substrate access port.

However, it is often necessary to trim liner sleeves of standard preformed length to a predetermined and precision shorter cut length compatible with the thickness of the substrate. This requirement for trimming of the liner sleeves has become more prevalent with increasing use of composite substrate materials, wherein such composite substrates are subject to a relatively broad tolerance range for thickness.

Since the length of the liner sleeve can be critical to insure proper installation and operational longevity of the associated nutplate assembly, there exists a need for a tool and related method for accurate precision trimming of the liner sleeve in a quick, easy, and cost-efficient manner. The present invention fulfills these needs and provides further related advantages.

### SUMMARY OF THE INVENTION

In accordance with the invention, a sleeve cutter and related cutting method are provided for precision cutting of a length of metal tubing or the like. The sleeve cutter and method are particularly designed for use in precision length trimming of tubular liner sleeves of the type used in mounting a nutplate assembly onto a substrate, of the general type disclosed in U.S. Pat. No. 5,704,747, which is incorporated by reference herein.

The sleeve cutter generally comprises a mandrel or spindle sized for slide-fit support of a tube-shaped liner sleeve or the like between a pair of rotary-driven cutting wheels. The cutting wheels are carried on a self-centering movable carriage unit adapted for movement of the two cutting wheels together between a retracted position spaced outwardly from the mandrel, and an advanced position with cutting edges in engagement with the mandrel-supported sleeve. The pair of cutting wheels thus engage and shear the sleeve to a precision predetermined length, with a force-balanced shearing action from opposite directions.

In the preferred form, each cutting wheel further includes a shaping step or land formed adjacent the associated cutting edge with a diametrically smaller size. These shaping steps or lands are positioned upon further advancement or slight over-travel of the cutting edges for engaging the sheared end of the tubular sleeve to remove any residual burr or flare from the cut sleeve end. If desired, these shaping steps or lands may be configured to impart a slight or controlled chamfer to the cut sleeve end.

The mandrel and cutting wheels are preferably mounted on a portable table for deployment and use, if desired, at a selected location. The mandrel is removably mounted onto the table, whereby one of a plurality of different mandrels of selected diametric size and axial length may be used for supporting a specific tubular sleeve to be cut. The diametric size of the selected mandrel accommodates quick and easy slide-fit mounting and removal of a tubular sleeve, while providing sufficient backstop support to preclude sleeve deformation during cutting.

In one form, the mandrel can be constructed with a hollow tubular geometry for quick and easy slide-fit mounting of a tubular sleeve having a closed outboard end. In this form, the hollow mandrel accommodates escape of air from the sleeve interior to achieve substantially resistant-free slide-on sleeve mounting. In one modified form, the hollow mandrel can be coupled to a suitable vacuum source for drawing residual air from the interior of the closed-end sleeve during slide-on mounting onto the mandrel.

Other features and advantages of the present invention will become apparent from the following more detailed description, taken in connection with the accompanying drawing which illustrate, by way of example, the principals of the present invention.

### BRIEF DESCRIPTION OF THE DRAWINGS

The accompanying drawings illustrate the invention. In such drawings:

FIG. 1 is a perspective view depicting the top and front sides of a sleeve cutter constructed in accordance with one preferred form of the invention;

FIG. 2 is a rear perspective view of the sleeve cutter shown in FIG. 1;

FIG. 3 is an enlarged perspective view depicting an exemplary tubular sleeve for cutting by means of the sleeve cutter shown in FIG. 1;

FIG. 3a is an enlarged perspective view similar to FIG. 3, but showing an alternative form of an exemplary tubular sleeve for cutting by means of the sleeve cutter shown in FIG. 1;

FIG. 4 is an enlarged and fragmented top perspective view of a portion of the sleeve cutter shown in FIGS. 1 and 2, with a tubular sleeve depicted in exploded relation with a support mandrel;

FIG. 5 is an enlarged and fragmented plan view of a portion of the sleeve cutter, and illustrating advancement of rotatable cutting wheels toward cutting engagement with the tubular sleeve to cut the sleeve to a predetermined length;

FIG. 6 is an enlarged and fragmented plan view similar to FIG. 5, but depicting the cutting wheels in cutting engagement with the tubular sleeve;

FIG. 7 is an enlarged and fragmented plan view similar to FIGS. 6 and 7, but showing advancement of a shaping step or land on each cutting wheel into engagement with the sheared sleeve; and

FIG. 8 is a top perspective view of a portion of the sleeve cutter, similar to FIG. 4, but showing a tubular sleeve having a closed outboard end mounted onto the support mandrel for cutting.

### DETAILED DESCRIPTION OF THE PREFERRED EMBODIMENT

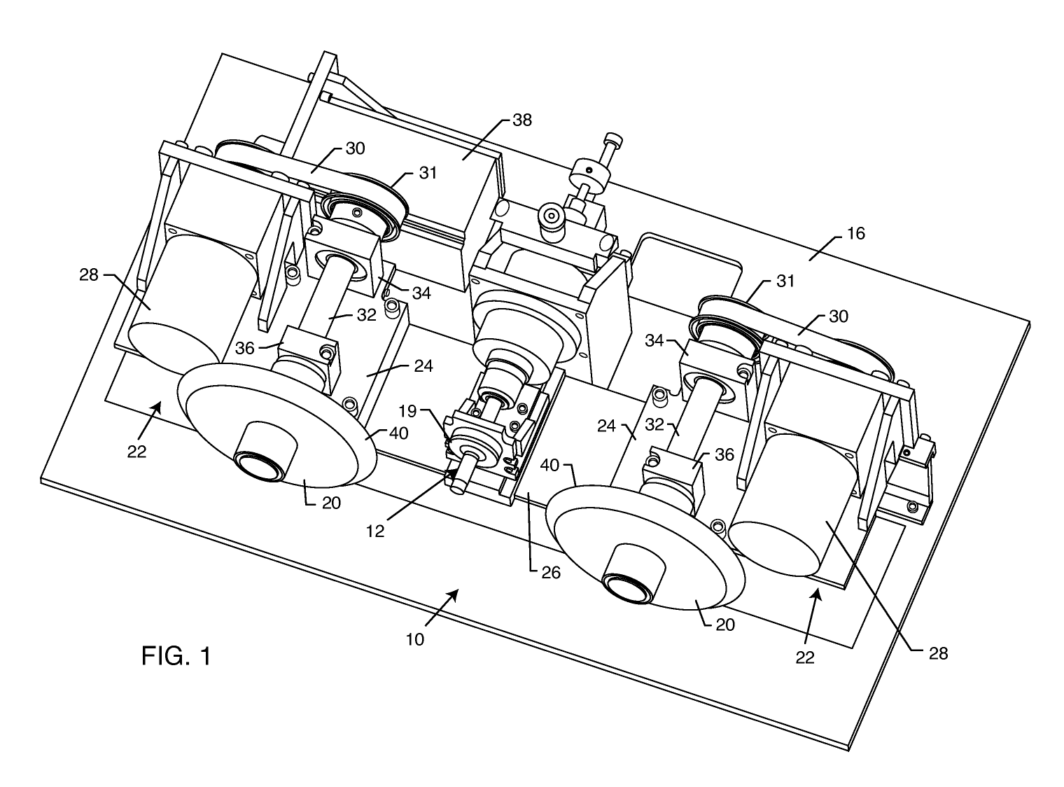

As shown in the exemplary drawings, a sleeve cutter referred to generally in FIG. 1 by the reference numeral 10, and related cutting method, are provided for precision length cutting of a sleeve 12 formed from metal tubing or the like. The sleeve cutter 10 is particularly designed for use in precision length trimming of liner sleeves 12 of the type used in mounting a nutplate assembly (not shown) onto a substrate, of the general type disclosed in U.S. Pat. No. 5,704,747 which is incorporated by reference herein.

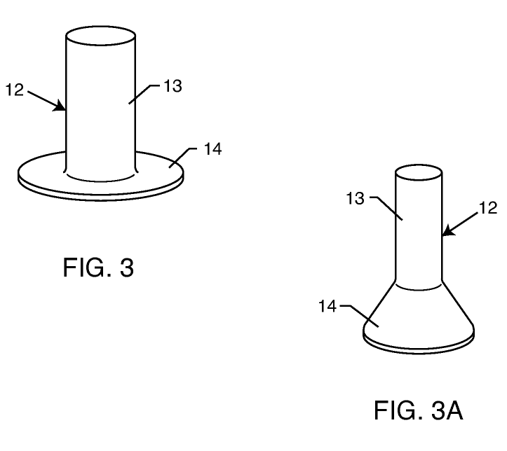

More specifically, liner sleeves 12 formed from a metal tube material such as a work hardened stainless steel are commonly provided for lining an access port formed in a substrate (not shown), in the course of installing a nutplate assembly onto a rear or blind side of the substrate. A fastener element such as a threaded screw or bolt can be passed rearwardly through the sleeve-lined access port for engagement with the nutplate assembly, for purposes of mounting various equipment items on the substrate, all as disclosed in U.S. Pat. No. 5,704,747. Such liner sleeves are normally constructed with a standard diametric size and a standard axial length, and typically also include a radially enlarged flange 14 (FIGS. 3 and 3a) at one end thereof. In this regard, FIGS. 3 and 3a illustrate two different typical sleeve configurations, each having an elongated tubular sleeve segment 13 joined at one end to the radially enlarged flange 14, wherein this flange 14 can be formed alternately to extend generally perpendicular to a central sleeve axis (FIG. 3), or to flare radially outwardly from one end of the tubular segment 13 (FIG. 3a).

In use, the tubular segment 13 of the liner sleeve 12 is fitted through the substrate access port (not shown) to limit or prevent hole wear, particularly in the case of a substrate formed from a composite or other non-metal material. The liner sleeve 12 also accommodates the use of standard-sized fasteners with an otherwise oversize substrate access port. However, it is often necessary to trim liner sleeves of standard preformed length to a predetermined and precision shorter cut length compatible with the actual thickness of the substrate. This requirement for trimming of the liner sleeves has become more prevalent with increasing use of composite substrate materials, wherein such composite substrates are subject to a relatively broad tolerance range for thickness. The sleeve cutter 10 of the present invention is designed for accurate precision trimming of the tubular segment of the liner sleeve 12 in a quick, easy, and cost-efficient manner.

The sleeve cutter 10 comprises a frame 16 preferably such as a portable table having a mandrel or spindle 18 (FIG. 4) of selected diametric size and axial length protruding from a bearing block 19. The mandrel 18 is sized for relatively close slide-fit reception thereon of a liner sleeve 12 thereon in an orientation with the flange 14 seated against the associated bearing block 19. In the most preferred form, the axial length of the mandrel 18 is selected to correspond closely with the desired cut length of the liner sleeve tubular segment 13. The mandrel 18 is removably mounted in any suitable manner known to persons skilled in the art, and may be interchanged to provide a specific selected mandrel diametric size and axial length.

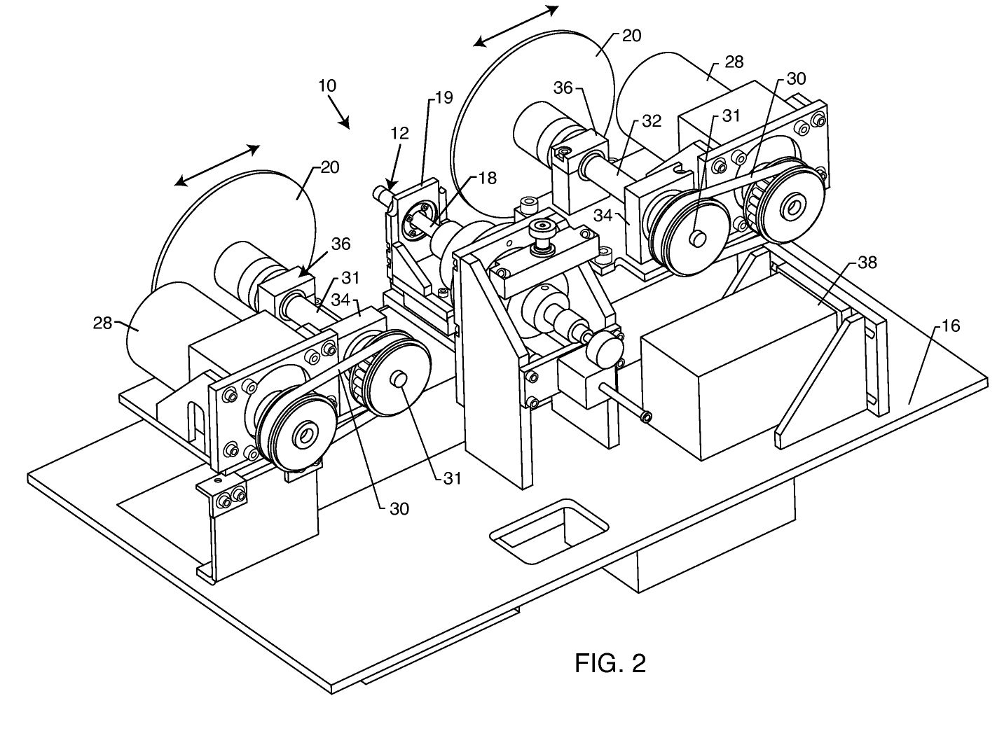

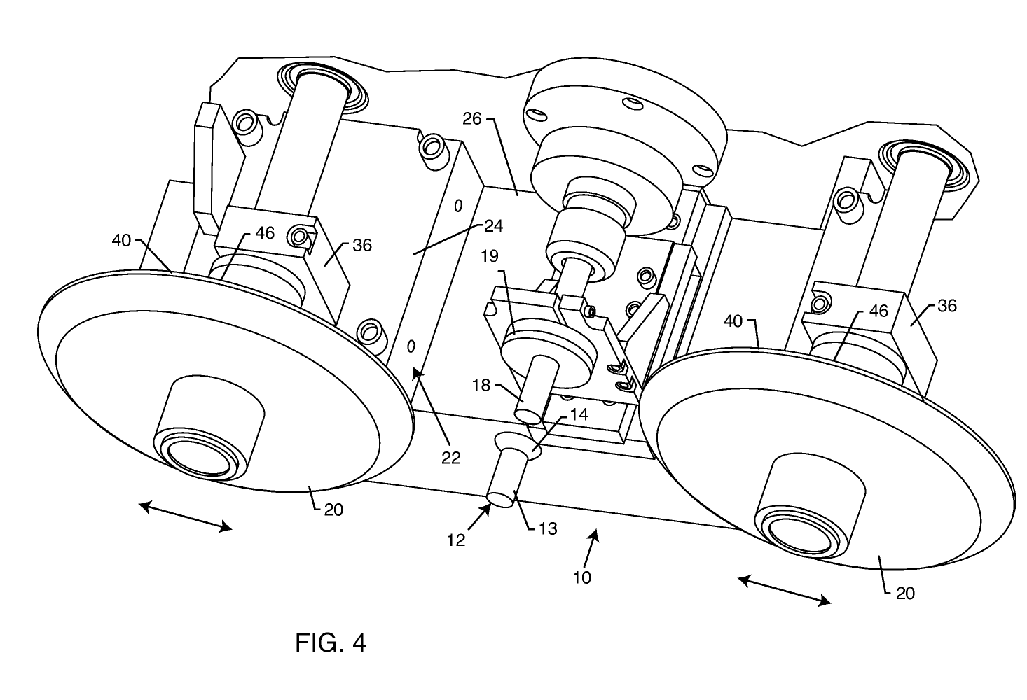

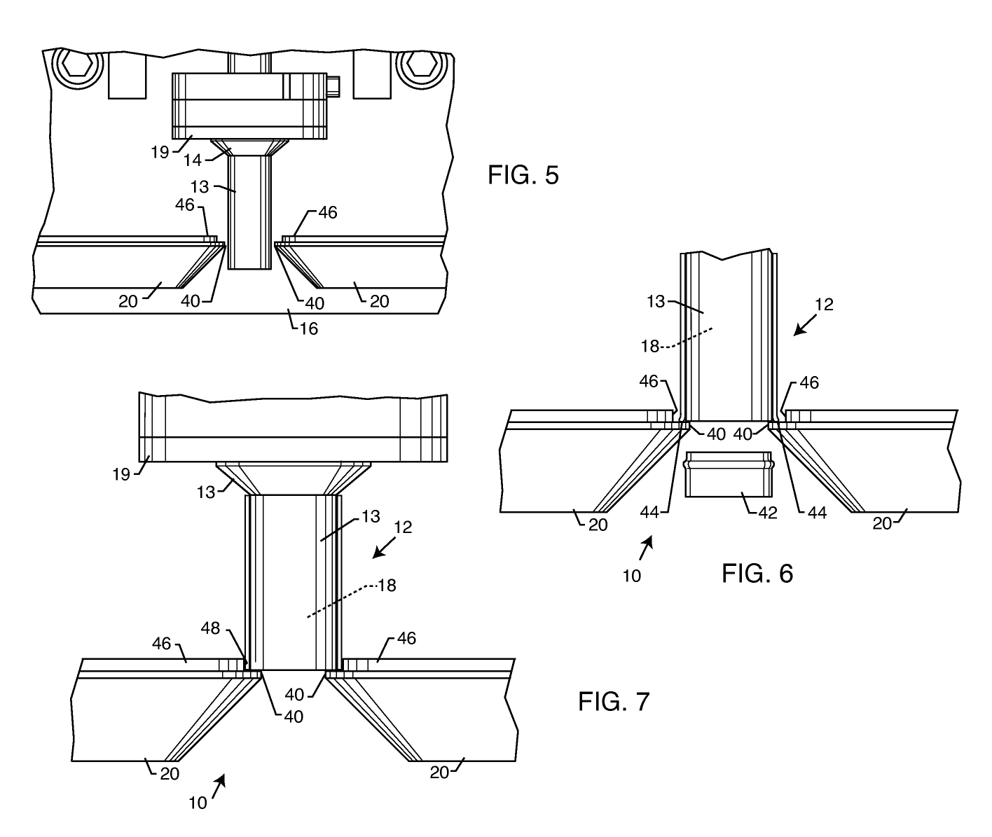

The mandrel 18 with liner sleeve 12 slidably mounted thereon is centrally positioned between a pair of rotary-driven cutting wheels 20 each mounted on a movable carriage 22 adapted for reciprocal shifting movement between a retracted position spaced laterally from the mandrel (FIGS. 1, 2 and 4) and an advanced position for engaging and shearing the tubular segment 13 of a liner sleeve 12 mounted on the mandrel 18 (FIGS. 5-7). More particularly, as shown in the illustrative drawings, each movable carriage 22 comprises a slide block 24 carried on a frame base 26 for sliding displacement between the retracted and advanced positions. The associated cutting wheel 20 is rotatably driven by a drive motor 28 mounted on the slide block 24 and coupled as by a drive or cog belt 30 and driven pulley 31 with a driven shaft 32 supported for rotation by bearing blocks 34 and 36, and carrying the cutting wheel 20. A linear actuator such as a servo motor unit 38 mounted on the frame or table 16 controllably displaces the two carriages 22 substantially in unison, and in a substantially self-centering manner relative to the mandrel axis, between the retracted and advanced positions.

In use, with the cutting wheels 20 in their respective retracted positions spaced laterally from the mandrel 18, a liner sleeve 12 is slide-fit installed onto the mandrel 18 with the sleeve flange 14 seated against the bearing block 19. In this orientation, with the drive motors 28 respectively driving the two cutting wheels 20 in a common rotational direction, the machine operator actuates the servo motor unit 38 to displace the movable carriages 22 with their respective cutting wheels 20 to the advanced position (FIGS. 5-7). In this advanced position, relatively sharp cutting edges 40 (FIG. 5-7) on the two cutting wheels 20 engage and shear the tubular segment 13 of the liner sleeve 12, thereby severing a waste or scrap piece 42 (FIG. 6) which can fall by gravity into a waste receptacle (not shown). Importantly, the servo motor unit 38 advances the two cutting wheels 20 for substantially concurrent and balanced-force shearing engagement acting in equal and opposite directions on the mandrel-supported liner sleeve 12.

As previously noted, in the preferred form, the axial length of the mandrel 18 is set to correspond generally with the desired axial length of the cut sleeve 12, whereby the mandrel provides a relatively rigid and sturdy backstop support to prevent significant liner sleeve deformation during the shearing step. In addition, by providing the mandrel 18 with a diametric size for close-fit slide-on mounting of the liner sleeve 12, the mandrel additionally supports the sleeve against significant diametric deformation during the shearing process. However, as illustrated best in FIG. 6, slight deformation and/or development of an undesired burr or flare 44 may still occur adjacent the shearing plane, i.e., immediately inboard of the point on contact between the cutting edges 40 of the cutting wheels 20 with the liner sleeve 12.

In accordance with a further aspect of the invention, each cutting wheel 20 additionally includes a shaping step or land 46 formed at an inboard side of the associated sharp cutting edge 40, wherein this land 46 defines a relatively flat and smooth axially extending step having a diametric size slightly less that the diametric size of the cutting edge 40. The servo motor unit 38 is designed for advancing the cutting wheels 40 sufficiently for slight over-travel of their cutting edges 40 for completely shearing off the scrap piece 42, but without causing the cutting edges 40 to move into contact with each other. Rather, after the cutting edges 40 displace inwardly to a position slightly beyond the inner diametric surface of the cut liner sleeve 12, the shaping lands 46 are displaced into contact with the outer diametric surface of the cut sleeve 12 in the immediate region of the cut end. As a result, the shaping lands 46 contact and remove any residual burr or flare 44, and may also be adapted to impart a selected chamfer 48 (FIG. 7) to the cut sleeve end.

The servo motor unit 38 then displaces the cutting wheels 20 back toward their respective retracted positions, to permit easy removal of the cut liner sleeve 12 from the mandrel 18, followed by slide-on placement of a subsequent liner sleeve 12 to be cut. Importantly, while the mechanical coupling details between the servo motor unit 38 and the carriages 22 carrying the cutting wheels 20 is not shown in detail herein, persons skilled in the art will recognize and appreciate that such servo-operated mechanisms adapted for reciprocal self-centered displacement are known in the art.

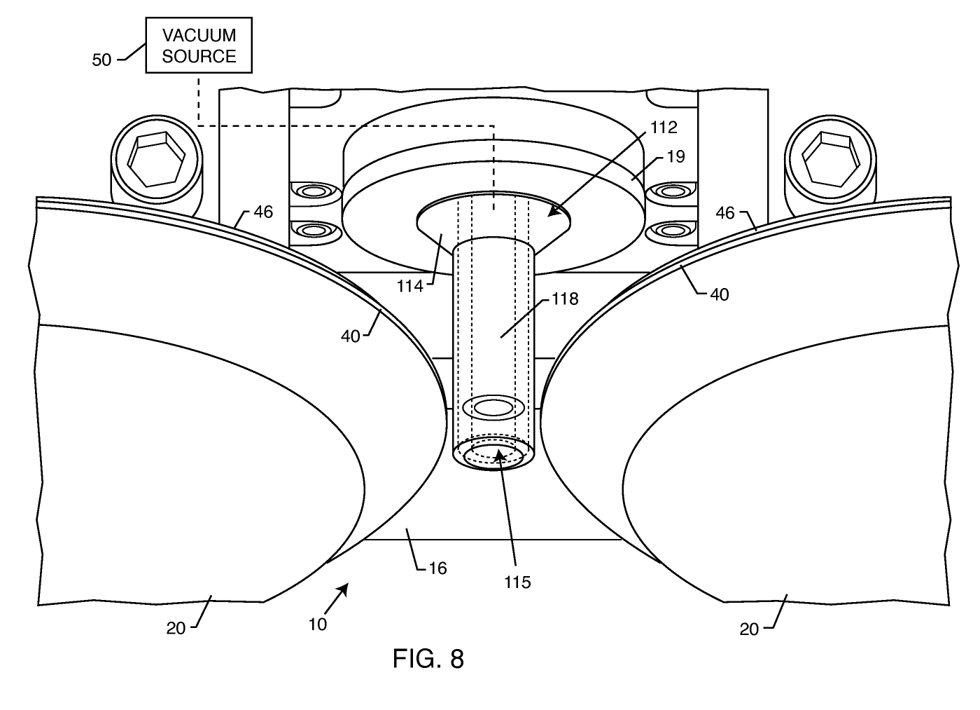

FIG. 8 depicts a modified form of the invention adapted particularly for trimming a modified liner sleeve 112 having a flange 114 at one end, and closed opposite end 115. In this embodiment, a modified mandrel 118 having a hollow tubular shape is used to accommodate close slide-on mounting of the liner sleeve 112 without trapping air between the end of the mandrel 118 and the closed end 115 of the liner sleeve 112. Instead, air in this space is exhausted through the hollow mandrel 118 to atmosphere, or, if desired, to a suitable vacuum source 50. The construction and operation of the embodiment depicted in FIG. 8 corresponds in other respects to the embodiment shown and described in FIGS. 1-7.

Although various embodiments and alternatives have been described in detail for purposes of illustration, various further modifications may be made without departing from the scope and spirit of the invention. Accordingly, no limitation on the invention is intended by way of the foregoing description and accompanying drawings, except as set forth in the appended claims.

What is claimed is:

1. A sleeve cutter for precision length cutting of a tubular sleeve, said sleeve cutter comprising:
a frame;
a mandrel carried by said frame, said mandrel having a diametric size and an axial length for relatively close slide-fit reception of a tubular sleeve thereon;
at least one rotary driven cutting wheel having a relatively sharp cutting edge for engaging and shearing the tubular sleeve; and
an actuator for reciprocally shifting said cutting wheel between a retracted position spaced laterally from said mandrel and a tubular sleeve thereon, and an advanced position with said cutting edge engaging and shearing a tubular sleeve on said mandrel;
said cutting wheel further including a shaping step disposed axially adjacent said cutting edge and having a diametric size less than the diametric size of said cutting edge, said actuator shifting said cutting wheel to said advanced position so that said shaping step contacts the sheared tubular sleeve on said mandrel to remove and/or to prevent formation of a residual burr or flare thereon.

2. The sleeve cutter of claim 1 wherein said mandrel is removably carried by said frame.

3. The sleeve cutter of claim 1 wherein said at least one rotary driven cutting wheel comprises a pair of cutting wheels each having said cutting edge and said shaping step formed thereon, and further wherein said actuator comprises means for shifting said cutting wheels together between said retracted and advanced positions for substantially self-centered and force-balanced shearing engagement with the tubular sleeve, when said cutting wheels are in said advanced positions.

4. The sleeve cutter of claim 3 wherein said actuator means comprises a linear actuator.

5. The sleeve cutter of claim 3 wherein said actuator means comprises a servo motor unit and a movable carriage mounted on said frame.

6. The sleeve cutter of claim 1 wherein said mandrel comprises a hollow spindle.

7. The sleeve cutter of claim 6 further including a vacuum source coupled to said hollow spindle.

8. A sleeve cutter for precision length cutting of a tubular sleeve, said sleeve cutter comprising:
a frame;
a mandrel removably carried by said frame, said mandrel having a diametric size and an axial length for relatively close slide-fit reception of a tubular sleeve thereon;
a pair of cutting wheels each having a relatively sharp cutting edge for engaging and shearing the tubular sleeve, and a shaping step disposed axially adjacent said cutting edge and having a diametric size less than the diametric size of said cutting edge; and
an actuator for reciprocally shifting said cutting wheels between a retracted position spaced laterally from said mandrel and a tubular sleeve thereon, and an advanced position with said cutting edges of said cutting wheels engaging and shearing a tubular sleeve on said mandrel with a substantially self-centered and force-balanced shearing engagement therewith, and with said shaping steps contacting the sheared tubular sleeve on said mandrel to remove and/or to prevent formation of a residual burr or flare thereon.

9. The sleeve cutter of claim 8 wherein said actuator means comprises a linear actuator.

10. The sleeve cutter of claim 9 wherein said actuator means comprises a servo motor unit and a movable carriage mounted on said frame.

11. The sleeve cutter of claim 8 wherein said mandrel comprises a hollow spindle.

12. The sleeve cutter of claim 11 further including a vacuum source coupled to said hollow spindle.

13. A method for precision length cutting of a tubular sleeve, said method comprising the steps of:
placing a tubular sleeve on a mandrel having a size and length for relatively close slide-fit mounting of the tubular sleeve thereon;
advancing at least one rotary driven cutting wheel into engagement with the mandrel-support sleeve, said cutting wheel having a relatively sharp cutting edge for engaging and shearing the tubular sleeve, and a shaping step disposed adjacent the cutting edge for engaging the sheared tubular sleeve to remove and/or to prevent formation of a residual burr or flare thereon.

14. The method of claim 13 wherein said shaping step has a diametric size less than said cutting edge.

15. The method of claim 13 including the step of mounting a pair of rotary driven cutting wheels on a movable carriage for shifting movement between a retracted position spaced laterally from said mandrel-supported sleeve, and an advanced position with relatively sharp cutting edges on said cutting wheels engaging and shearing the tubular sleeve with a substantially self-centered and force-balanced shearing engagement therewith, and with shaping steps on said cutting wheels disposed adjacent said cutting edges for engaging the sheared tubular sleeve to remove and/or prevent formation of a residual burr or flare thereon.

16. The method of claim 15 said shaping step on each of said cutting wheels has a diametric size less than said cutting edge.

17. The method of claim 13 further including the step of forming the mandrel as a hollow spindle.

18. The method of claim 17 further including the step of coupling the hollow spindle with a vacuum source.
